(19) United States
(12) Patent Application Publication
(10) Pub. No.: US 2026/0215560 A1
(43) Pub. Date: Jul. 30, 2026

(54) PORTABLE STORAGE DEVICE

(71) Applicants: ZHONGSHAN LEEKAIGAI PACKAGING CO., LTD, Zhongshan, Guangdong (CN); SHENZHEN RELX TECHNOLOGY CO., LTD., Baoan District, Shenzhen, Guangdong (CN)

(72) Inventors: Zhongming DONG, Zhongshan, Guangdong (CN); Hekun XIAO, Zhongshan, Guangdong (CN); Yan ZHANG, Baoan District ,Shenzhen, Guangdong (CN); Rui GAN, Baoan District ,Shenzhen, Guangdong (CN)

(73) Assignees: ZHONGSHAN LUCKCAP PACKAGING CO., LTD, Zhongshan, Guangdong (CN); SHENZHEN RELX TECHNOLOGY CO., LTD., Baoan District, Shenzhen, Guangdong (CN)

(21) Appl. No.: 19/123,124

(22) PCT Filed: Jan. 26, 2025
(86) PCT No.: PCT/CN2025/075329

§ 371 Date: Apr. 22, 2025

(30) Foreign Application Priority Data
Dec. 10, 2024 (CN) 202423055355.9

(51) Int. Cl. A45C 11/20; A45C 13/00; B65D 53/02

(52) U.S. Cl. CPC A45C 11/20; A45C 13/005; B65D 53/02; B65D 2209/00

(57) ABSTRACT

A portable storage device is disclosed, including a cylindrical container, a first cover body, and a second cover body. The cylindrical container is internally provided with a partition dividing the cylindrical container into a first compartment and a second compartment. A first opening corresponding to the first compartment and a first sealing plate corresponding to the second compartment are arranged at a top of the cylindrical container, and a second sealing plate corresponding to the first compartment and a second opening corresponding to the second compartment are arranged at a bottom of the cylindrical container. The first cover body is hinged to a top edge of the cylindrical container and is configured to be sealingly fitted with the top of the cylindrical container, and the second cover is hinged to a bottom edge of the cylindrical container and is configured to be sealingly fitted with the second opening.

### TECHNICAL FIELD

The present disclosure belongs to the technical field of daily necessities, and specifically, relates to a portable storage device.

### BACKGROUND

While traveling or engaging in outdoor activities, people usually bring some snacks with them. These snacks need to be stored in portable containers to facilitate carrying during travel or outdoor activities. Some snacks, such as individually wrapped candies, biscuits, chewing gum or shelled nuts, generate waste when consumed. However, during travel or outdoor activities, trash bins may not always be readily accessible, leaving no proper place to dispose of such waste. This often leads to littering, which has a detrimental impact on the environment.

### SUMMARY

In view of the above, an objective of the present disclosure is to provide a portable storage device capable of storing snacks and to solve the problem of how to store waste generated during the consumption of these snacks.

In order to achieve the above objective, the following technical solutions are used in the present disclosure.

A portable storage device includes a cylindrical container, a first sealing cover, and a second sealing cover, where the cylindrical container is internally provided with a partition extending in a height direction of the cylindrical container and dividing the cylindrical container into a first compartment and a second compartment;
a first opening corresponding to the first compartment and a first sealing plate corresponding to the second compartment are arranged at a top of the cylindrical container, and a second sealing plate corresponding to the first compartment and a second opening corresponding to the second compartment are arranged at a bottom of the cylindrical container; and
the first sealing cover is hinged to a top edge of the cylindrical container and is configured to be sealingly fitted with the top of the cylindrical container, and the second sealing cover is hinged to a bottom edge of the cylindrical container and is configured to be sealingly fitted with the second opening.

In a preferred embodiment, the first sealing cover includes a first cover body and a first sealing ring connected to a lower surface of the first cover body, where the first sealing ring has a shape adapted to the first opening, and when the first cover body is sealingly fitted with the top of the cylindrical container, the first sealing ring is tightly fitted to a side wall of the first opening and is embedded into the first opening.

In a preferred embodiment, a first end of the first cover body is hinged to the top edge of the cylindrical container by means of a first hinge; and a second end of the first cover body, which is opposite to the first end, is provided with a first cover handle that protrudes in an arc shape.

In a preferred embodiment, a first recess is provided in an outer wall of the top edge of the cylindrical container, at a position corresponding to the first cover handle.

In a preferred embodiment, the second sealing cover includes a second cover body and a second sealing ring connected to a lower surface of the second cover body, where the second sealing ring has a shape adapted to the second opening, and when the second cover body is configured to be sealingly fitted with the second opening, the second sealing ring is tightly fitted to a side wall of the second opening and is embedded into the second opening.

In a preferred embodiment, a first end of the second cover body facing away from the second sealing plate is hinged to the bottom edge of the cylindrical container by means of a second hinge, a second end of the second cover body facing the second sealing plate is provided with a second cover handle, and an edge of the second sealing plate is provided with a second recess for accommodating the second cover handle; and when the second cover body is sealingly fitted with the second opening, the second cover body is aligned with the second sealing plate, and the second cover handle is embedded into the second recess.

In a preferred embodiment, an indentation is provided in the second recess, and when the second cover handle is embedded into the second recess, the second cover handle covers a portion of the indentation.

In a preferred embodiment, a volume of the first compartment is 3-5 times larger than a volume of the second compartment.

In a preferred embodiment, a cross-section of the cylindrical container is in a shape of a circle or a polygon.

In a preferred embodiment, a width of the cylindrical container in a radial direction is multiple times greater than a height of the cylindrical container, such that the portable storage device has a flat structure as a whole.

The portable storage device provided by the embodiments of the present disclosure is provided with a first compartment and a second compartment separated from each other. The first compartment can store snacks and other foods, and the second compartment can store waste generated during the consumption of these foods, thereby facilitating storage and carrying of snacks and other foods during travel or outdoor activities, and providing an easy way to dispose of the waste generated from consuming these foods without littering, thus preventing environmental pollution.

Further, the openings of the first and second compartments are arranged in opposite directions, preventing accidentally placing waste into the compartment intended for storing food.

### BRIEF DESCRIPTION OF DRAWINGS

FIG. 1 is a cross-sectional view of a portable storage device in an embodiment of the present disclosure;

FIG. 2 is a perspective view of the top of a portable storage device in an embodiment of the present disclosure;

FIG. 3 is a structural diagram of the portable storage device as shown in FIG. 2 when a first sealing cover is in an open state;

FIG. 4 is a perspective view of the bottom of a portable storage device in an embodiment of the present disclosure;

FIG. 5 is a structural diagram of the portable storage device as shown in FIG. 4 when a second sealing cover is in an open state;

FIG. 6 is a structural diagram of a portable storage device in an embodiment of the present disclosure when both a first sealing cover and a second sealing cover are in an open state;

FIGS. 7 to 13 are structural diagrams of portable storage devices in other embodiments of the present disclosure; and

FIG. 14 illustrates an exemplary relative positional relationship between a first hinge and a second hinge in an embodiment of the present disclosure.

### DETAILED DESCRIPTION

In order to make the objective, technical solutions and advantages of the present disclosure clearer, the embodiments of the present disclosure will be described in detail below in conjunction with the accompanying drawings. Examples of these embodiments are illustrated in the accompanying drawings. The embodiments shown in drawings and described according to the drawings are merely illustrative, and the present disclosure is not limited to these embodiments.

It should be noted that same or similar reference numerals in the drawings of the embodiments of the present disclosure indicate same or similar components. It is to be understood that, in the description of the present disclosure, the terms “upper”, “lower”, “left”, “right”, etc., which indicate positional and directional relationships, are based on the orientation shown in the drawings. These terms are used only for the convenience of describing the present disclosure and simplifying the description, rather than indicating or implying that the device or element referred to must have a specific orientation or be constructed and operated in a specific orientation. Therefore, the terms describing positional relationships in the drawings are for illustration purposes only and are not intended to limit the present disclosure. For those of ordinary skills in the art, the specific meanings of the above terms can be understood according to specific circumstances.

It should also be noted that, to avoid obscuring the present disclosure with unnecessary details, only the structures and/or processing steps tightly related to the solutions of the present disclosure are shown in the drawings while other details that are not tightly related to the present disclosure are omitted.

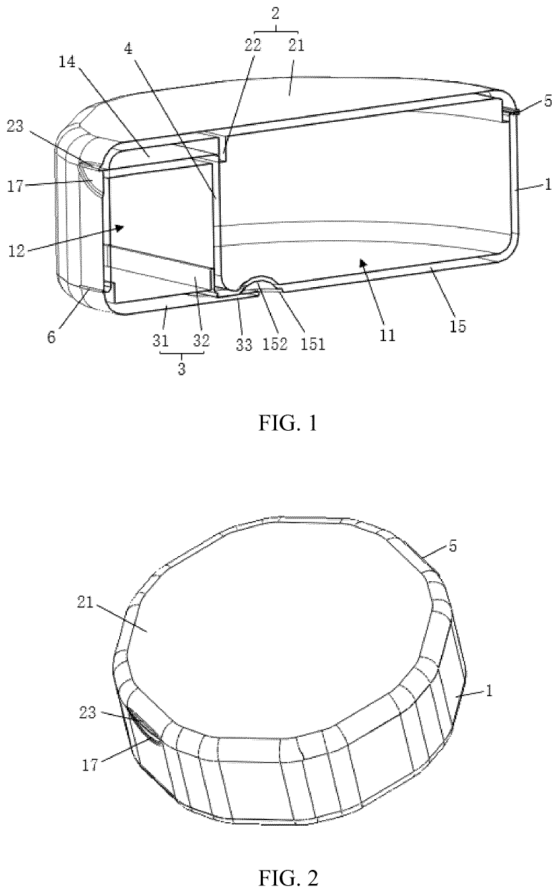

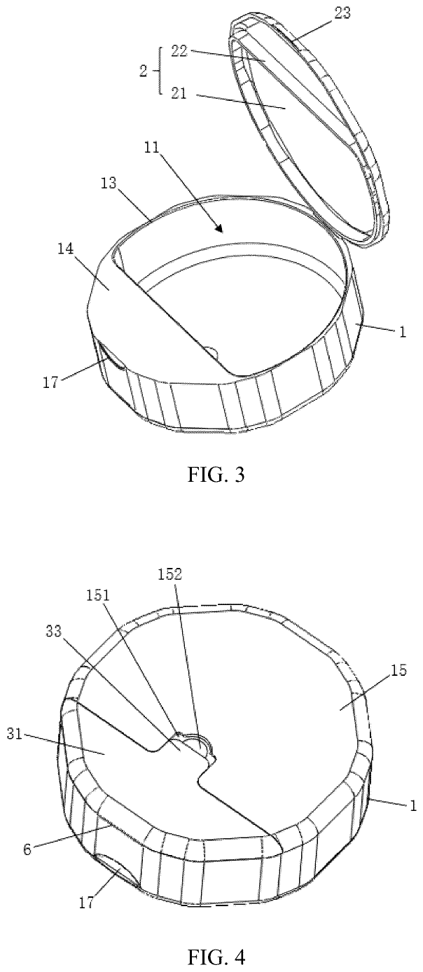

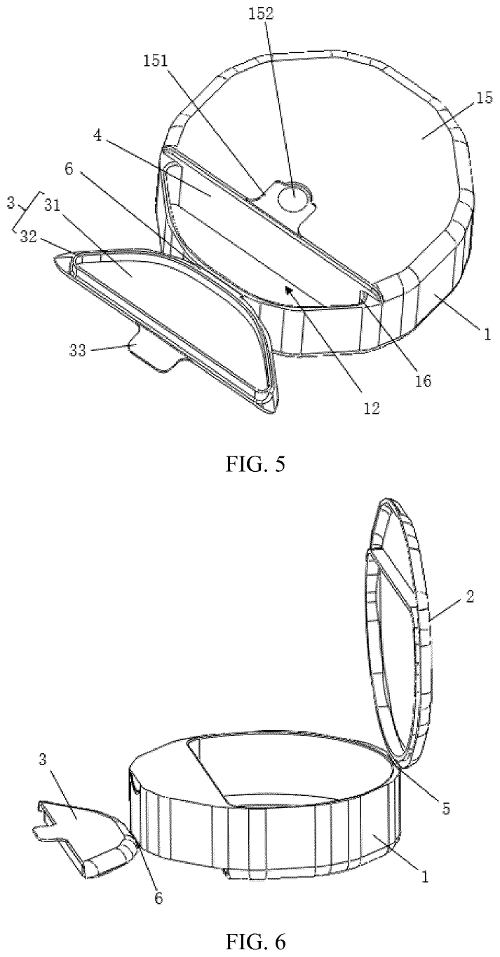

An embodiment of the present disclosure provides a portable storage device. Referring to FIGS. 1 to 6, the portable storage device mainly includes a cylindrical container 1, a first sealing cover 2, and a second sealing cover 3. The cylindrical container 1 is internally provided with a partition 4 that extends in a height direction of the cylindrical container 1 and divides the cylindrical container 1 into a first compartment 11 and a second compartment 12.

A first opening 13 corresponding to the first compartment 11 and a first sealing plate 14 corresponding to the second compartment 12 are arranged at a top of the cylindrical container 1. A second sealing plate 15 corresponding to the first compartment 11 and a second opening 16 corresponding to the second compartment 12 are arranged at a bottom of the cylindrical container 1. The first sealing cover 2 is hinged to a top edge of the cylindrical container 1 and is configured to be sealingly fitted with the top of the cylindrical container 1. The second sealing cover 3 is hinged to a bottom edge of the cylindrical container 1 and is configured to be sealingly fitted with the second opening 16.

In the portable storage device, the first compartment 11 is mainly used to store snacks or other foods, and the compartment 12 is mainly used to store waste generated during the consumption of these foods, for example, wrappers or packaging from individually wrapped candies, biscuits, chewing gum, as well as nutshells or other similar food residues. The openings of the first compartment 11 and the second compartment 12 are arranged in opposite directions, which can prevent accidentally placing waste into the compartment intended for storing foods.

In a specific embodiment, the first sealing cover 2 includes a first cover body 21 and a first sealing ring 22 connected to a lower surface of the first cover body 21, and the first cover body 21 is configured to be sealingly fitted with the top of the cylindrical container 1

The first sealing ring 22 has a shape adapted to the first opening 13. When the first cover body 21 is sealingly fitted with the top of the cylindrical container 1, the first sealing ring 22 is tightly fitted to a side wall of the first opening 13 and is embedded into the first opening 13. The first opening 13 of the first compartment 11 can be well sealed by means of the first sealing ring 22.

Further, a first end of the first cover body 21 is hinged to the top edge of the cylindrical container 1 by means of a first hinge 5. A second end of the first cover body 21, which is opposite to the first end, is provided with a first cover handle 23 that protrudes in an arc shape. By means of the first cover handle 23, a user can easily open the first cover body 21 (i.e., the first sealing cover 2) from the cylindrical container 1.

In a more preferred embodiment, a first recess 17 is provided in an outer wall of the top edge of the cylindrical container 1, at a position corresponding to the first cover handle 23. By providing the first recess 17 in combination with the first cover handle 23, it is more convenient for a user to open the first cover body 21.

In a specific embodiment, the second sealing cover 3 includes a second cover body 31 and a second sealing ring 32 connected to a lower surface of the second cover body 31. The second cover body 31 is configured to be sealingly fitted with the second opening 16, and the second sealing ring 32 has a shape adapted to the second opening 16. When the second cover body 31 is sealingly fitted with the second opening 16, the second sealing ring 32 is tightly fitted to a side wall of the second opening 16 and is embedded into the second opening 16. The second opening 16 of the second compartment 12 can be well sealed by means of the second sealing ring 32.

Further, a first end of the second cover body 31 facing away from the second sealing plate 15 is hinged to the bottom edge of the cylindrical container 1 by means of a second hinge 6. A second end of the second cover body 31 facing the sealing plate 15 is provided with a protruding second cover handle 33. An edge of the second sealing plate 15 is provided with a second recess 151 for accommodating the second cover handle 33. When the second cover body 31 is sealingly fitted with the second opening 16, the second cover body 31 is aligned with the second sealing plate 15, and the second cover handle 33 is embedded into the second recess 151. By means of the second cover handle 33, a user can easily open the second cover body 31 (i.e., the second sealing cover 3) from the cylindrical container 1.

In a more preferred embodiment, an indentation 152 is provided in the second recess 151. When the second cover handle 33 is embedded into the second recess 151, the second cover handle 33 covers a portion of the indentation 152. By providing the indentation 152 in combination with the second cover handle 33, it is more convenient for a user to open the second cover body 31.

As a preferred embodiment, in the cylindrical container 1, the volume of the first compartment 11 is 3-5 times larger than that of the second compartment 12. The compartment 11 is used for storing snacks or other foods, and the second compartment 12 is used for storing waste generated during the consumption of these foods. Therefore, the volume of the first compartment 11 is set to be larger than that of the second compartment 12. In the case where the size of the cylindrical container 1 is determined, a volume ratio of the first compartment 11 to the second compartment 12 can be adjusted by changing the specific position of the partition 4 within the cylindrical container 1.

As a preferred embodiment, referring to FIG. 1, a width of the cylindrical container 1 in a radial direction is multiple times greater than a height of the cylindrical container 1, such that the portable storage device has a flat structure as a whole. Therefore, while having a large storage capacity, the portable storage device can be more convenient to carry.

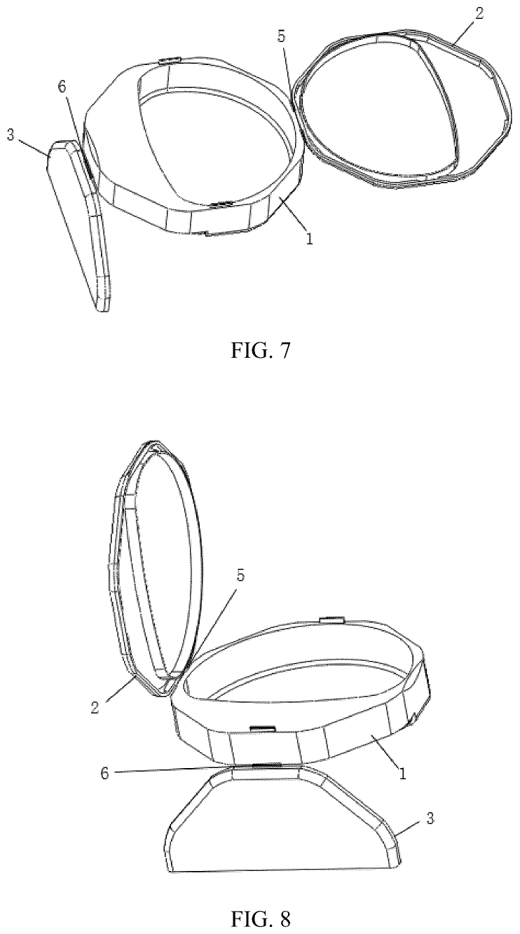

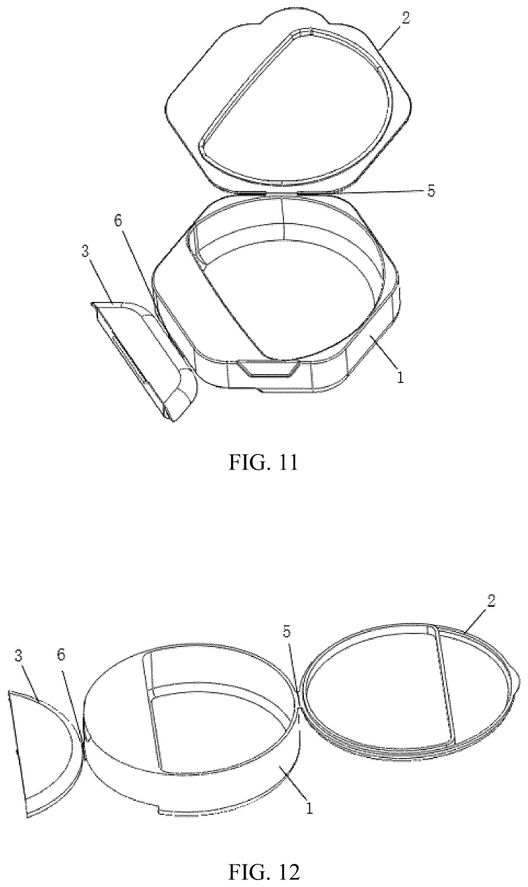

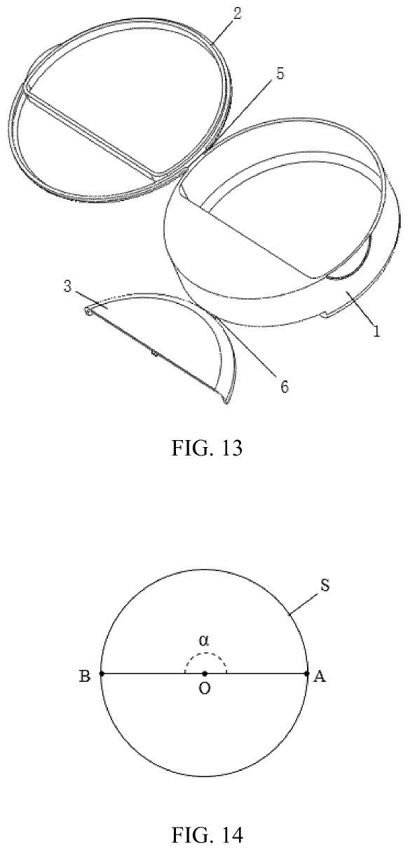

The cross-section of the cylindrical container 1 is preferably in the shape of a circle or a polygon. For example, in this embodiment, for the portable storage devices shown in FIGS. 1 to 6, the cross-section of the cylindrical container 1 is a polygon with multiple sides, which is approximately a circle. FIGS. 7 to 13 are structural diagrams of portable storage devices in other embodiments. It should be noted that, for the portable storage devices shown in FIGS. 7 to 13, the first sealing cover 2 and the second sealing cover 3 are in an open state. For the portable storage devices shown in FIGS. 7 to 9, the cross-section of the cylindrical container 1 is octagonal. For the portable storage devices shown in FIGS. 10 and 11, the cross-section of the cylindrical container 1 is hexagonal. For portable storage devices shown in FIGS. 12 and 13, the cross-section of the cylindrical container 1 is circular.

For the portable storage devices provided by the embodiments of the present disclosure, opening directions of the first sealing cover 2 and the second sealing cover 2 can be changed by adjusting a position relationship between the first hinge 5 and the second hinge 6, according to actual needs.

FIG. 14 illustrates an exemplary relative positional relationship between a first hinge 5 and a second hinge 6. Referring to FIG. 14 in conjunction with FIGS. 6 to 13, S represents the top plane of the cylindrical container 1 (see the circular plane as an example in FIG. 14), O represents the center point of the top plane S, A represents a position point of the first hinge 5 on the top plane, and B represents a position point corresponding to a projection of the second hinge 6 on the top plane. The lines connecting the center point O with the position point A and the position point B respectively form an angle α.

By adjusting the relative positional relationship between the first hinge 5 and the second hinge 6, the angle a can vary between 0° and 180°.

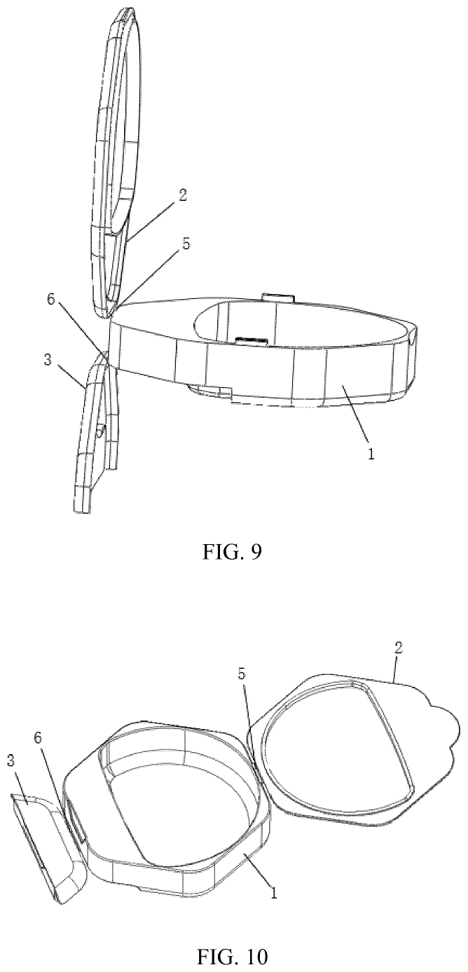

When the angle α is 180°, and the position point B projected by the second hinge 6 on the top plane and the position point A corresponding to the first hinge 5 are located on opposite sides of the center point O, such configuration corresponds to the structures of the portable storage devices shown in FIGS. 6, 7, 10 and 12. In this case, the first sealing cover 2 and the second sealing cover 3 are opened in opposite directions. When the angle a is 0°, and the position point B projected by the second hinge 6 on the top plane coincides with the position point A corresponding to the first hinge 5, such configuration corresponds to the structure of the portable storage device shown in FIG. 9. In this case, the first sealing cover 2 and the second sealing cover 3 are opened in the same direction. The angle a may also be set to 90°, such as the structures of the portable storage devices shown in FIGS. 8 and 13. The angle a may also be set to other angles between 0° and 180°, such as the structure of the portable storage device shown in FIG. 11.

In summary, a portable storage device provided by the embodiments of the present disclosure is provided with a first compartment and a second compartment that are separated from each other, where the first compartment can store snacks and other foods and the second compartment can store waste generated during the consumption of these foods, thereby facilitating storage and carrying of snacks and other foods during travel or outdoor activities, and providing an easy way to dispose of the waste generated from consuming these foods without littering, thus preventing environmental pollution. Further, the openings of the first compartment and the second compartment are arranged in opposite directions, preventing accidentally placing waste into the compartment intended for storing food.

The above description are only specific embodiments of the present disclosure. It should be noted that, for those of ordinary skills in the art, several improvements and refinements can be made without departing from the gist of the present disclosure. These improvements and refinements are intended to be within the scope of protection of the present disclosure.

1. A portable storage device, comprising a cylindrical container, a first sealing cover, and a second sealing cover, wherein the cylindrical container is internally provided with a partition extending in a height direction of the cylindrical container and dividing the cylindrical container into a first compartment and a second compartment;
wherein a first opening corresponding to the first compartment and a first sealing plate corresponding to the second compartment are arranged at a top of the cylindrical container, and a second sealing plate corresponding to the first compartment and a second opening corresponding to the second compartment are arranged at a bottom of the cylindrical container; and
wherein the first sealing cover is hinged to a top edge of the cylindrical container and is configured to be sealingly fitted with the top of the cylindrical container, and the second sealing cover is hinged to a bottom edge of the cylindrical container and is configured to be sealingly fitted with the second opening.

2. The portable storage device according to claim 1, wherein the first sealing cover comprises a first cover body and a first sealing ring connected to a lower surface of the first cover body, wherein the first sealing ring has a shape adapted to the first opening, and in case that the first cover body is sealingly fitted with the top of the cylindrical container, the first sealing ring is tightly fitted to a side wall of the first opening and is embedded into the first opening.

3. The portable storage device according to claim 2, wherein a first end of the first cover body is hinged to the top edge of the cylindrical container by means of a first hinge; and a second end of the first cover body, which is opposite to the first end, is provided with a first cover handle that protrudes in an arc shape.

4. The portable storage device according to claim 3, wherein a first recess is provided in an outer wall of the top edge of the cylindrical container, at a position corresponding to the first cover handle.

5. The portable storage device according to claim 1, wherein the second sealing cover comprises a second cover body and a second sealing ring connected to a lower surface of the second cover body, wherein the second sealing ring has a shape adapted to the second opening, and in case that the second cover body is sealingly fitted with the second opening, the second sealing ring is tightly fitted to a side wall of the second opening and is embedded into the second opening.

6. The portable storage device according to claim 4, wherein a first end of the second cover body facing away from the second sealing plate is hinged to the bottom edge of the cylindrical container by means of a second hinge, a second end of the second cover body facing the second sealing plate is provided with a second cover handle, and an edge of the second sealing plate is provided with a second recess for accommodating the second cover handle; and in case that the second cover body is sealingly fitted with the second opening, the second cover body is aligned with the second sealing plate, and the second cover handle is embedded into the second recess.

7. The portable storage device according to claim 6, wherein an indentation is provided in the second recess, and in case that the second cover handle is embedded into the second recess, the second cover handle covers a portion of the indentation.

8. The portable storage device according to claim 1, wherein a volume of the first compartment is 3-5 times larger than a volume of the second compartment.

9. The portable storage device according to claim 1, wherein a cross-section of the cylindrical container is in a shape of a circle or a polygon.

10. The portable storage device according to claim 9, wherein a width of the cylindrical container in a radial direction is multiple times greater than a height of the cylindrical container, such that the portable storage device has a flat structure as a whole.
